(19) United States
(12) Patent Application Publication
(10) Pub. No.: US 2023/0023155 A1
(43) Pub. Date: Jan. 26, 2023

(54) BASKETBALL SHOOTING APPARATUS

(71) Applicant: Dennis ADOMAKO, Montreal (CA)

(72) Inventor: Dennis ADOMAKO, Montreal (CA)

(21) Appl. No.: 17/788,287

(22) PCT Filed: Sep. 8, 2020
(86) PCT No.: PCT/CA2020/051206

§ 371 Date: Jun. 22, 2022

(51) Int. Cl. A63B 69/00; A63B 71/06; A63B 24/00

(52) U.S. Cl. CPC A63B 69/0071; A63B 71/0669; A63B 24/0021; A63B 2063/001

(57) ABSTRACT

A basketball shooting apparatus is disclosed. The apparatus comprises a backboard and rim assembly having a backboard positioned in parallel with ground and ceiling and a rim member attached in perpendicular to the backboard. The apparatus further comprises an assistive learning system (ALS), a frame, and a motion tracking system. The ALS is attached to the backboard to perform score-keeping, intelligent instruction providing, and mode changing during shooting practice. The frame comprises a net attached at its peripheral ends to support the backboard and rim assembly and ALS. The motion tracking system comprises one or more tracking devices positioned on and/or around a user capable of capturing, inferring, or allowing the inference of three-dimensional motion from the user's arms, hands and wrists. The ALS provides visual feedback regarding the user's shooting form via a visual display, thereby training the user at their learning phase of developing proper shooting techniques.

### FIELD OF THE INVENTION

The present invention generally relates to sports training equipment and training techniques. More particularly, the present invention relates to a basketball practice and training equipment configured to assist an individual in improving their basketball shooting skills.

### BACKGROUND

Sports training is a process of systematic preparation of an individual sportsperson or team to achieve their full potential and perform optimally in a particular competition. Sports training includes—physiological conditioning, psychological training, skill training, and training of game plan or strategy. The game of basketball requires physical strength and conditioning, and also requires special skills. Repetitive practice is required for the successful development of such skills.

Basketball handling and shooting are the most important fundamental skills to basketball players. Basketball players often spend a considerable amount of time practicing basketball shooting. Basketball players often practice basketball shooting by taking repetitive shots from one location on a basketball court, and then repeat the same process at different locations on the basketball court. Therefore, the basketball players may improve their ability to make basketball shots from different angles or distances on the basketball court.

However, if a second player is not present to rebound, the shooter must spend time to rebound their own shots, which results in less efficient shooting practice as the basketball player spends less time on actual shooting practice. Thus, the rebounding process may waste time that would otherwise be used in taking more shots. In addition, retrieving basketball rebounds may affect the basketball player's shooting pattern that they are building throughout the shooting practice. Various basketball training equipment has been developed to collect basketball shots at the basketball court.

Few existing patent references attempted to address problems cited in the background as prior art over the presently disclosed subject matter are explained as follows:

A prior art U.S. Pat. No. 4,805,917 A to Ken C. Cochran, et. al., entitled “Basketball game” discloses a basketball game comprising a framework and basket, and a gate for controlling access to the balls. The gate is mounted to a shooting window having an opening for passage of the balls. A gate bar is moveable to a position blocking the opening and is coupled with a pair of solenoids with vertically extendable and retractable plungers. Rigid upper and lower return boards are forwardly inclined for returning the balls more quickly to the player by reducing the vertical component of the ball movement. Netting and vinyl coupled with the framework prevent the balls from bouncing away.

Another prior art WO2011025362 A1 to Seng Lee Koo entitled “Basketball game apparatus” discloses a basketball apparatus for both basketball game or practice. The apparatus has a ball return structure and a ball return channel that returns basketballs thrown by the players in the general direction of the basketball hoop. More than one basketball hoop at different height is provided and can be selected by the player to vary the level of difficulty. A height-adjustable barricade and a retractable ball return means are included and used together with basketball hoops at different heights to provide further variation of levels of difficulty.

Another prior art U.S. Pat. No. 4,838,549 A to Bliss T. Woodall entitled “Basketball retriever device” discloses a basketball retriever device including an elongated chute having a bottom panel, upright side panels, and an open rear end, and adapted to fit around a basketball basket to guide a basketball shot to the vicinity of the basket and to guide the return of the basketball to the front end of the chute. A basketball receiver device includes a cradle beneath the front end of the chute for receiving the returned basketball and an extensible ramp member for guiding the balls from the chute to a variety of shooting positions for a basket player. The retriever device further includes auxiliary closure panels for closing the area adjacent the rear end of the chute when the chute is disposed at angles to the basketball backboard other than a perpendicular position relative to the backboard.

Another prior art US20110281672 A1 to Douglas Brad Campbell, et. al., entitled “Basketball return apparatus” discloses a basketball return apparatus having an L-shaped frame, a net, and a ball return mechanism. The frame has a back portion and a base portion. The back portion has an upper end adapted to mount on a rim support bracket of the basketball hoop and center and stabilize the frame with respect to the basketball hoop. The back portion has side members that connect to the upper end and extend generally vertically downward to connect to the base portion. The base portion defines an orifice through which shot basketballs can descend. The net is attached to the frame to form open funnel shaped enclosure with an open top end and an open bottom end. The enclosure directs basketballs downward therethrough to the base portion. The ball return mechanism is mounted to the frame below the orifice and net to direct the basketballs back to the shooter.

Though the existing prior arts disclose various basketball training equipment, these prior efforts sometimes yield a poor user experience to provide basketball shooting training. Also, the existing prior arts fail to disclose the novel structure of the current basketball shooting apparatus. Further, the existing prior arts lack to disclose the novel placement of the basket and the use of gravity to return the ball to the shooter.

In light of all the above-mentioned drawbacks, there is a need for a basketball training equipment by providing a portable solution for a player at any level to practice their shot. Also, there is a need for a training equipment that eliminates the need for a human coach or trainer to be present during the learning phase of developing proper shooting techniques.

### SUMMARY OF THE INVENTION

The present invention discloses a basketball shooting apparatus configured to assist an individual in improving their basketball shooting skills. Also, the present invention discloses a basketball training equipment by providing a portable solution for a player at any level to practice their shot. Further, the present invention discloses a basketball training equipment that eliminates the need for a human coach or trainer to be present during the learning phase of developing proper shooting techniques.

In one embodiment, the apparatus comprises a backboard and rim assembly. In one embodiment, the backboard and rim assembly are at a novel position parallel to the ground. The backboard and rim assembly comprises a backboard positioned in parallel with the ground and ceiling, and a rim member or hoop attached in perpendicular to the backboard. In one embodiment, the apparatus further comprises an assistive learning system (ALS) attached to the backboard. In one embodiment, the assistive learning system is configured to perform score-keeping, intelligent instruction providing, and mode changing during shooting practice. In one embodiment, the assistive learning system continuously tracks the points scored by the user during training and provides skill-testing games at various difficulty levels to improve the user's shooting skills.

In one embodiment, the apparatus further comprises a frame configured to support the backboard and rim assembly and the assistive learning system. The frame comprises an upper portion and a lower portion or bottom portion or base. In one embodiment, the frame is wide enough at the upper portion to securely support the backboard and rim member. In one embodiment, the frame is wide enough at the lower portion to allow the user to lay inside and have plenty of space to employ proper shooting formation, and motion. In one embodiment, the frame is light enough to allow a single person to move it around yet sturdy enough to allow for longevity.

In one embodiment, a net is attached at the peripheral ends of the frame. In one embodiment, the net is designed to keep a ball from escaping the frame and may catch the ball when the user shoots through the rim member. In one embodiment, the frame has an area at the lower portion for the user to lay in. In one embodiment, the assistive learning system allows the user to choose different game modes from their laying position.

In one embodiment, the apparatus further comprises a protective material or protective restraining material and an assistive learning system (ALS). The protective material eliminates the need for a re-bounder or a return mechanism. In one embodiment, the protective material is a very small mesh material that keeps the ball from leaving the frame on rebounds, attached to the backboard, and tightly wrapped around the frame, preventing the ball from escaping the frame. The protective material covers the whole frame, backboard, and rim member from top to bottom to keep the ball from leaving the frame on rebounds and catch the ball when the user shoots through the rim member. In one embodiment, the ball is a lightweight custom-sized rubber ball to be used on the apparatus.

In one embodiment, the apparatus further comprises a motion tracking system mounted at the upper portion of the frame to avoid damage from the ball. In one embodiment, the motion tracking system having one or more tracking devices positioned on and/or around the user capable of capturing, inferring, or allowing the inference of three-dimensional motion from the user's arms, hands, and wrists. In one embodiment, the motion tracking system comprises one or more optical instruments positioned towards the user configured to record moving images and still images. The one or more optical instruments capture the movement of the arms, wrists, and hands of the user. The images are used to compare the user's execution of the activity to a baseline or norm, in order to give them feedback on their shooting technique.

In one embodiment, the one or more tracking devices comprise any combination of an optical instrument and a wired or wireless inertial measurement unit. In one embodiment, the optical instrument is capable of collecting information regarding the user by recording still or moving images of the user's right and left arm, hand, and wrist. In one embodiment, the wired or wireless inertial measurement unit is capable of collecting information regarding the three-dimensional trajectory of the ball by measuring various factors in all x, y, and z directions. In one embodiment, the factors may include, but are not limited to, orientation, acceleration, rate of rotation, and magnetic field. In one embodiment, the apparatus further comprises one or more clips mounted at the lower portion of the frame. The clips are used to mount accessories to the assistive learning system.

During basketball shooting training, the images recorded by the optical instruments are digitally transmitted to a computer as an input to a first model. The first model may be a mathematical model, statistical model, analytical model, artificially intelligent model, or any other combination thereof. The first model infers three dimensional trajectory of the ball by measuring various factors in all x, y, and z directions. In one embodiment, the factors may include, but are not limited to, angular position, angular orientation, angular acceleration, rate of rotation, and magnetic field. In one embodiment, the processing model infers angular position, angular velocity, and angular acceleration of the user's upper arms, forearms, and hands from the input images. Then, a second model uses the output of the first model as input, comparing the user's angular data to a baseline or norm, and outputs the difference in angular position, angular velocity, and angular acceleration of the user's upper arms, forearms, and hands. The result from the second model is then used to render an animation, showing the user how similar or different their execution while comparing with the baseline or norm. The visual rendering appears on a visual display in front of the user, for example, on the backboard of the apparatus. In the visual rendering, the user's replayed movements are superimposed on the baseline or norm.

Other objects, features, and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 shows a front perspective view of a basketball shooting apparatus, according to one embodiment of the present invention.

FIG. 2 shows a side perspective view of the basketball shooting apparatus, according to one embodiment of the present invention.

FIG. 3 shows an enlarged view of a backboard and rim assembly, according to one embodiment of the present invention.

FIG. 4 shows a side view of the basketball shooting apparatus in a typical use case, according to one embodiment of the present invention.

### DETAILED DESCRIPTION OF EMBODIMENTS

The present invention is best understood by reference to the detailed figures and description set forth herein.

It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

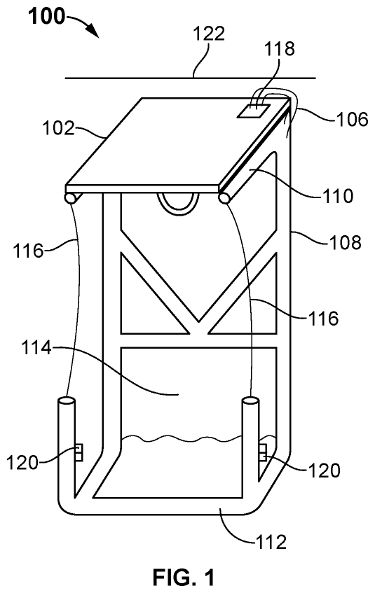

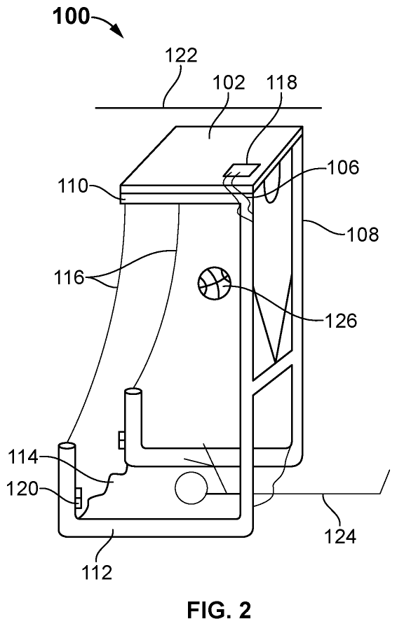

Referring to FIG. 1, a front perspective view of a basketball shooting apparatus (hereinafter referred as apparatus) 100, according to one embodiment of the present invention. The apparatus 100 is an effective and intelligent basketball practice and training tool. The apparatus 100 is a novel basketball training instrument that has been designed to be an effective and portable solution for player/user 124 (as shown in FIG. 2) at any level to practice their shot. The apparatus 100 eliminates the need for a human coach or teacher to be present during the learning phase of developing proper shooting techniques by providing a teaching and learning system that is capable of providing realtime feedback to show the user 124 how to employ proper upper body shooting mechanics. In one embodiment, the apparatus 100 provides an alternate solution to practice shooting technique at a traditional indoor/outdoor basketball hoop which to accomplish efficiently. The apparatus 100 may methodically develop, improve, and/or change the shooting form of the user 124 by shooting more frequently while using less time. In one embodiment, the apparatus 100 provides privacy and comfort to user 124 by easily relocating to any room or open area.

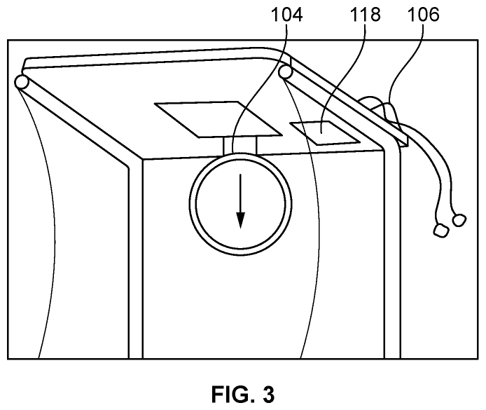

In one embodiment, the apparatus 100 comprises a backboard and rim assembly. In one embodiment, the backboard and rim assembly are at a novel position parallel to the ground. The backboard and rim assembly comprises a backboard 102 positioned in parallel with the ground and ceiling 122, and a rim member or hoop 104 (as shown in FIG. 3) attached in perpendicular to the backboard 102.

In one embodiment, the apparatus 100 further comprises an assistive learning system (ALS) with a motion tracking system 118 attached to the backboard. In one embodiment, the assistive learning system comprises a processor configured to provide one or more instructions to perform various operations and a memory in communication with the processor configured to store the operational data. In one embodiment, the assistive learning system keeps track of how many times the player scores. Also, it facilitates the play of games that are designed to be fun yet, challenging enough to improve the user's shooting efficiency.

In one embodiment, the assistive learning system is configured to perform scorekeeping, intelligent instruction providing, and mode changing during shooting practice. In one embodiment, the assistive learning system continuously tracks the points scored by the user 124 during training and provides skill-testing games at various difficulty levels to improve the user's shooting skills. In one embodiment, the assistive learning system may interact with the user 124 to teach a correct shot technique, and shooting formation. In one embodiment, the assistive learning system further comprises one or more ALS game mode switches 106 configured to change the game mode based on the user desire.

In one embodiment, the apparatus 100 further comprises a frame 108 configured to support the backboard and rim assembly and the ALS with motion tracking system 118. In one embodiment, the frame 108 is a vertical tall support structure. The frame 108 comprises an upper portion 110 configured to support the backboard 102 and a lower portion or bottom portion or base 112 configured to place the apparatus 100 over the ground surface. In one embodiment, the frame 108 is wide enough at the upper portion 110 to securely support the backboard 102 and rim member 104. In one embodiment, the frame 108 is wide enough at the lower portion 112 to allow the user 124 to lay inside and have plenty of space to employ proper shooting formation, and motion. In one embodiment, the frame 108 has an area 114 at the lower portion 112 for the user 124 to lay in.

In one embodiment, the apparatus 100 further comprises a protective material or protective restraining material 116. The protective material 116 eliminates the need for a re-bounder or a return mechanism. In one embodiment, the motion tracking system is mounted at the upper portion 110 of the frame 108. In one embodiment, the ALS with motion tracking system 118 further comprises one or more optical instruments and motion tracking devices 120 positioned on and/or around the user 124 configured to provide visual feedback regarding the user's shooting form. In one embodiment, the one or more motion tracking devices positioned on and/or around the user 124 are capable of capturing, inferring, or allowing the inference of three-dimensional motion from the user's arms, hands, and wrists. In one embodiment, the one or more optical instruments positioned towards the user 124 are configured to record moving images and still images. The one or more optical instruments capture the movement of the arms, wrists, and hands of the user 124. The images are used to compare the user's execution of the activity to a baseline or norm, in order to give them feedback on their shooting technique. In one embodiment, the apparatus 100 further comprises one or more clips mounted at the lower portion 112 of the frame 108.

Referring to FIG. 2, a side perspective view of the apparatus 100, according to one embodiment of the present invention. In one embodiment, the apparatus 100 comprises a backboard and rim assembly. The backboard and rim assembly comprises a backboard 102 positioned in parallel with the ground and ceiling 122, and a rim member or hoop 104 (as shown in FIG. 3) attached in perpendicular to the backboard 102. In one embodiment, the backboard and rim assembly of any size may be tilted to about 90 degrees so that the backboard 102 is parallel to the ground. In one embodiment, the apparatus 100 further comprises an assistive learning system (ALS) with a motion tracking system 118 attached to the backboard. In one embodiment, the assistive learning system is configured to perform score-keeping, intelligent instruction providing, and mode changing during shooting practice. In one embodiment, the assistive learning system continuously tracks the points scored by the user 124 during training and provides skill-testing games at various difficulty levels to improve the user's shooting skills.

In one embodiment, the apparatus 100 further comprises a frame 108 configured to support the backboard and rim assembly and the ALS with motion tracking system 106. The frame 108 comprises an upper portion 110 and a lower portion or bottom portion or base 112. In one embodiment, the frame 108 is wide enough at the upper portion 110 to securely support the backboard 102 and rim member 104. In one embodiment, the frame 108 is wide enough at the lower portion 112 to allow the user 124 to lay inside and have plenty of space to employ proper shooting formation, and motion. In one embodiment, the frame 108 is light enough to allow a single person to move it around yet sturdy enough to allow for longevity.

In one embodiment, the frame 108 comprises a built-in opening at its lower portion 112 configured to allow the user 124 to lay on their back and engage with the apparatus 100. The opening allows the user 124 to lay inside the frame 108 and operate the ALS with motion tracking system 106. The opening allows generous mobility. In one embodiment, the frame 108 has an area 114 at the lower portion 112 for the user 124 to lay in. In one embodiment, the assistive learning system has one or more ALS game mode switches 106 configured to allow the user 124 to choose different game modes from their laying position.

In one embodiment, the apparatus 100 further comprises a protective material or protective restraining material 116 and an assistive learning system (ALS). The protective material 116 eliminates the need for a re-bounder or a return mechanism. In one embodiment, the protective material 116 is a very small mesh material that keeps a ball 126 from leaving the frame 108 on rebounds, attached to the backboard 102, and tightly wrapped around the frame 108, preventing the ball 126 from escaping the frame 108. The protective material 116 covers the whole frame 108, backboard 102, and rim member 104 from top to bottom to keep the ball 126 from leaving the frame 108 on rebounds and catch the ball 126 when the user 124 shoots through the rim member 104. In one embodiment, the ball 126 is a lightweight custom-sized rubber ball to be used on the apparatus 100.

In one embodiment, the user 124 may select the practicing mode at any time using ALS game mode switches 106. The novel shot practice position allows for shooting practice without the need to use the lower body. The user 124 has their whole upper body up to waist within the area 114 with the user's legs and lower body outside of the frame 108. In one embodiment, the frame 108 is small enough so that the user 124 does need not move from the laying position to retrieve the ball. By laying in this position, the user 124 may shoot the ball 126 up against the gravity into the rim member 104, and try to score points, or practice their technique with the assistive learning system.

In one embodiment, the motion tracking system is mounted at the upper portion 110 of the frame 108 to avoid damage from the ball. In one embodiment, the ALS with motion tracking system 118 comprises one or more optical instruments and motion tracking devices 120 positioned on and/or around the user 124 configured to provide visual feedback regarding the user's shooting form. In one embodiment, the one or more motion tracking devices positioned on and/or around the user 124 are capable of capturing, inferring, or allowing the inference of three-dimensional motion from the user's arms, hands, and wrists. In one embodiment, the one or more optical instruments positioned towards the user 124 are configured to record moving images and still images. The one or more optical instruments capture the movement of the arms, wrists, and hands of the user 124. The images are used to compare the user's execution of the activity to a baseline or norm, in order to give them feedback on their shooting technique.

In one embodiment, the one or more tracking devices comprise any combination of an optical instrument and a wired or wireless inertial measurement unit. In one embodiment, the optical instruments with motion tracking devices are capable of collecting information regarding the user 124 by recording still or moving images of the user's right and left arm, hand, and wrist. In one embodiment, the wired or wireless inertial measurement unit is capable of collecting information regarding the three dimensional trajectory of the ball 126 by measuring various factors in all x, y, and z directions. In one embodiment, the factors may include, but are not limited to, orientation, acceleration, rate of rotation, and magnetic field.

During basketball shooting training, the images recorded by the optical instruments with motion tracking devices are digitally transmitted to a computer as an input to a first model. The first model may be a mathematical model, statistical model, analytical model, artificially intelligent model, or any other combination thereof. The first model infers three-dimensional trajectory of the ball 126 by measuring various factors in all x, y, and z directions. In one embodiment, the factors may include, but are not limited to, angular position, angular orientation, angular acceleration, rate of rotation, and magnetic field. In one embodiment, the processing model infers angular position, angular velocity, and angular acceleration of the user's upper arms, forearms, and hands from the input images. Then, a second model uses the output of the first model as input, comparing the user's angular data to a baseline or norm, and outputs the difference in angular position, angular velocity, and angular acceleration of the user's upper arms, forearms, and hands. The result from the second model is then used to render an animation, showing the user 124 how similar or different their execution while comparing with the baseline or norm. The visual rendering appears on a visual display in front of the user 124, for example, on the backboard of the apparatus. In the visual rendering, the user's replayed movements are superimposed on the baseline or norm.

Referring to FIG. 3, an enlarged view of the backboard and rim assembly, according to one embodiment of the present invention. In one embodiment, the backboard and rim assembly are at a novel position parallel to the ground. The position of the backboard and rim assembly creates a unique advantage of being able to apply realistic basketball shooting form and shooting velocity with the apparatus 100. The positioning of the backboard and rim assembly forces the user/shooter 124 to follow through in order to get the ball 126 through the rim member 104 at a high percentage. The follow-through motion enforces the release of the ball 126 at the correct time which helps to achieve the perfect arc, which is postulated to be at 45-50 degrees. The same shooting velocity and shooting form are applied while shooting anywhere from 0-35 feet on a traditional basketball hoop.

In one embodiment, the positioning of the backboard and rim assembly allows the user 124 to use gravity as an assistant to add resistance to the trajectory of the ball 126 being shot up and down within the frame 108, which mimics the difficulty and arm strength needed for a long range shot within the apparatus 100. Due to the shooting of regular shot, many possibilities arise such as being able to train a player's off hand with the same technique for shooting efficiently. The backboard and rim assembly comprises a backboard 102 positioned in parallel with the ground and ceiling 122, and a rim member 104 attached in perpendicular to the backboard 102. In one embodiment, the assistive learning system mounted at the backboard 102 includes one or more ALS game mode switches 106 that allows the user 124 to choose different game modes from their laying position.

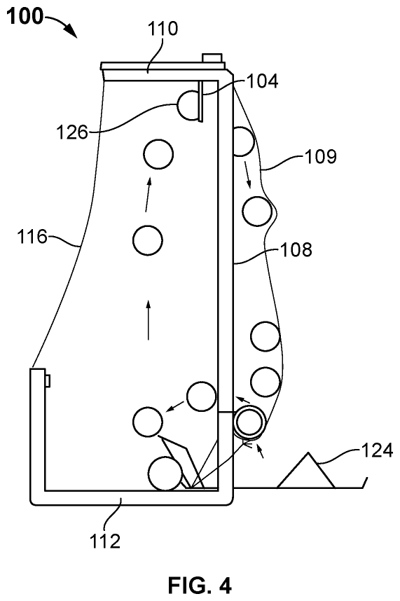

Referring to FIG. 4, a side view of the basketball shooting apparatus 100 in a typical use case, according to one embodiment of the present invention. In one embodiment, a net 109 is attached at the peripheral ends of the frame 108. In one embodiment, a net 109 is attached at the peripheral ends of the frame 108. The user 124 is allowed to shoot the ball 126 from their laying position towards the rim member 104. It assists the user 124 in improving their basketball shooting skills during the learning phase to develop proper shooting techniques. In one embodiment, the net 109 is designed to keep the ball 126 from escaping the frame 108, and may catch the ball 126 when the user 124 shoots through the rim member 104.

Advantageously, the basketball shooting apparatus of the present invention is designed in a dimension that allows it to fit within a moderately small room with a regular size ceiling for convenience of practice location. The apparatus may be disassembled or re-positioned by moving and sliding around the practice location. The apparatus provides a novel way for someone interested in basketball to practice shooting techniques in a comfortable setting or just to have fun shooting in setting of their choosing. The apparatus gives the ability to practice long-range shooting within a small area like a small apartment or garage. The lightweight frame allows one to easily move the apparatus around to where one feels comfortable using it. Being a great teaching tool, the apparatus provides everyday leisure fun for basketball enthusiasts of all ages by providing a score-keeping system and captivating games that one may utilize by themselves if they so wish. Further, it is apparent that the apparatus provides a new way for the user to shoot for fun, or shoot with the intent of training their shooting technique on a novely positioned rim and backboard while putting the user in a unique nontraditional yet comfortable position.

Preferred embodiments of this invention are described herein, including the best mode known to the inventors for carrying out the invention. It should be understood that the illustrated embodiments are exemplary only and should not be taken as limiting the scope of the invention.

The foregoing description comprises illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings in the foregoing descriptions. Although specific terms may be employed herein, they are used only in generic and descriptive sense and not for purposes of limitation. Accordingly, the present invention is not limited to the specific embodiments illustrated herein.

1.-8. (canceled)

9. A basketball shooting apparatus, comprising:
a backboard and rim assembly having a backboard positioned in parallel with the ground and ceiling, and a rim member attached in perpendicular to the backboard;
an assistive learning system (ALS) attached to the backboard, including a processor configured to provide one or more instructions to perform various operations and a memory in communication with the processor configured to store the operational data;
a frame having a net attached at its peripheral ends configured to support the backboard and rim assembly and assistive learning system; and
a motion tracking system having one or more tracking devices positioned on and/or around a user capable of capturing, inferring, or allowing the inference of three-dimensional motion from the user's arms, hands, and wrists,
wherein the assistive training system provides visual feedback regarding the user's shooting form via a visual display, thereby guiding and training the user at any level to practice their shot without the need for a human coach or trainer to be present during the learning phase of developing proper shooting technique.

10. The apparatus of claim 9, wherein the assistive learning system is configured to perform score-keeping, intelligent instruction providing, and mode changing during shooting practice.

11. The apparatus of claim 9, wherein the assistive learning system continuously tracks the points scored by the user during training and provides skill-testing games at various difficulty levels to improve the user's shooting skills.

12. The apparatus of claim 9, wherein the net is designed to keep a ball from escaping the frame and catch the ball when the user shoots through the rim member.

13. The apparatus of claim 9, wherein the frame comprises an opening built-in at its bottom portion configured to allow the user to lay on their back and engage with the apparatus.

14. The apparatus of claim 1, wherein the one or more tracking devices comprise any combination of:
an optical instrument capable of collect information regarding the user by recording still or moving images of the user's right and left arm, hand, and wrist, and
a wired or wireless inertial measurement unit capable collect information regarding three-dimensional trajectory of the ball by measuring orientation, acceleration, rate of rotation, and magnetic field in x, y, and z directions.

15. The apparatus of claim 14, wherein the information collected from the tracking devices are compared to a baseline or a norm using a mathematical model, statistical model, analytical model, an artificial intelligence model, or any other combination thereof to generate a numerical result that is provided as the feedback to the user on the visual display.

16. The apparatus of claim 9, further comprising a protective material configured to cover the whole frame, backboard, and rim member from top to bottom to keep the ball from leaving the frame on rebounds and catch the ball when the user shoots through the rim member.
